(19) United States
(12) Patent Application Publication
(10) Pub. No.: US 2009/0308529 A1
(43) Pub. Date: Dec. 17, 2009

(54) METHOD OF MANUFACTURING A LAMINATED PAPERBOARD WITH AN OPAQUE PLASTIC FILM FOR PRINTING A COLOR LABEL THEREON

(76) Inventor: Kuo-tzu Chiu, Tianjin (CN)

Correspondence Address: SAM CHEN, 7F-1, 293, ROOSEVELT ROAD, SEC 3, TAIPEI, TW

(21) Appl. No.: 12/544,217

(22) Filed: Aug. 19, 2009

Related U.S. Application Data
(62) Division of application No. 11/928,734, filed on Oct. 30, 2007.

(51) Int. Cl. B32B 38/10

(52) U.S. Cl. 156/269

(57) ABSTRACT

In one embodiment a method of manufacturing a laminated paperboard includes feeding a reel of opaque plastic (e.g., PP, PVC, PET, or PE) film to a first pressing device and feeding a reel of paper member (e.g., paper or paperboard) under the plastic film to the first pressing device; activating the first pressing device to apply a first adhesive on a joining surface of the passing paper member and the passing plastic film; activating a drying device to dry the first adhesive to fasten the plastic film and the paper member together to form a laminated paperboard; feeding the laminated paperboard to a color gravure device; activating the color gravure device to print a color label on the top surface of the laminated paperboard by applying ink thereon; and feeding the laminated paperboard to a cutter for cutting the laminated paperboard into a plurality of units of predetermined size.

### CROSS REFERENCE TO RELATED APPLICATION

This application is a divisional application of U.S. application Ser. No. 11/928,734 filed Oct. 30, 2007, the contents of which are incorporated herein by reference.

### BACKGROUND OF THE INVENTION

1. Field of Invention

The invention relates to paperboard manufacturing processes and more particularly to a method of manufacturing a laminated paperboard having an opaque plastic (e.g., PP (polypropylene), PE (polyethylene), PVC (polyvinyl chloride), or PET (polyethylene terephthalate)) film (i.e., synthetic paper) bonded on its top surface with a color label being adapted to print on the plastic film.

2. Description of Related Art

Conventional paperboard for packaging can be classified as one for water-based ink-jet printing and one for color printing. Paperboard for water-based ink-jet printing is typically formed of brown kraft paper laminated with corrugated fiberboard by means of a pressing device. Paperboard for water-based ink-jet printing is of relatively cheap and relatively low in quality.

A method of manufacturing paper containers of color comprises printing a color label on a top surface of, for example, white paperboard of high quality and high cost, joining a bottom surface of the white paperboard with kraft paper, and finally joining a bottom surface of the kraft paper with corrugated paper.

The conventional color printing method has difficulties of printing a color label on reels of paper. Moreover, the cost of printing a color label on the surface of paperboard for quality container is relatively high. Recently, there is a type of paperboard having a transparent OPP (oriented polypropylene) film formed thereon. Color label can be printed on the bottom surface of the OPP film by means of gravure and the type of paperboard can be used for the manufacturing of containers having a moisture resistant characteristic. But this is unsatisfactory for the purpose for which the invention is concerned for the following reasons:

Only the bottom surface of the paperboard can be printed with color by means of gravure. Hence, only white paperboard can be used as the material. The paper container manufacturing process only allows the steps of printing first and adhering second rather than adhering first and printing second. The step of adhering OPP film to white paperboard is effected by applying water-based glue therebetween and heating. However, bubbles tend to form in the product and the bubbles can adversely affect the printing quality. Color superposition and/or color being not registration can exit on the OPP film due to the longitudinal and transverse stretches of the OPP film during printing. Fully automatic printing process is very difficult and its cost is prohibitively high. Thus, the need for improvement still exists.

### SUMMARY OF THE INVENTION

It is therefore one object of the invention to provide a method of manufacturing a laminated paperboard having an opaque plastic (e.g., PP, PE, PET, or PVC) film bonded on its top surface with a color label being adapted to print on the plastic film.

The above and other objects, features and advantages of the invention will become apparent from the following detailed description taken with the accompanying drawings.

### BRIEF DESCRIPTION OF THE DRAWINGS

FIG. 1 is a longitudinal sectional view of a preferred embodiment of laminated paperboard manufactured according to the invention.

### DETAILED DESCRIPTION OF THE INVENTION

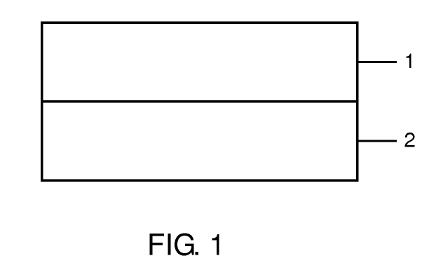

Referring to FIG. 1, a process of manufacturing a laminated paperboard in accordance with a preferred embodiment of the invention is illustrated below.

The top layer 1 of the laminated paperboard is formed of an opaque plastic film (e.g., PP film in this embodiment). The plastic film is called synthetic paper in the art. Note that the plastic film can be replaced with PE, PVC, or PET film in other embodiments. The bottom layer 2 of the laminated paperboard is white paperboard in this embodiment. Note that the white paperboard can be replaced with paper thinner than the white paperboard in other embodiments.

The process of manufacturing the laminated paperboard can be performed by either a) printing first and adhering second or b) adhering first and printing second.

For printing first and adhering second, it involves the following steps.

First step: Place a reel of opaque PP film 1 of (e.g., 12 μm thick and 2.6 m wide) in front of an inlet of, for example, a multiple color gravure machine capable of printing, for example, 8-color in this embodiment. The thickness of the PP film 1 is in the range of 12 μm to 180 μm and the width of the PP film 1 is less than that of the gravure machine as required by the invention. Activate the gravure machine to print a color label on the top surface of the PP film 1. Ink for the printing is synthetic ink. Preferably, the consumption of the ink is only about one-third to about one-half as that required by a conventional color printing process. Also, a drying device is provided. The drying device can be a fan for blowing air current, a UV based heating device, an IR based heating device, or the like.

Second step: Place the PP film 1 printed with the color label in front of an inlet of a pressing device (e.g., one including two opposing rolls) and align the former with a container filled with a reel of paperboard 2 of (e.g., 260 μm thick and 1,100 mm wide) thereunder. The thickness of the paperboard 2 is in the range of 60 μm to 800 μm and the width of the PP film 1 is less than that of the pressing device as required by the invention respectively.

Third step: Activate the pressing device to apply an adhesive on the top surface of the passing paperboard 2 which is adapted to join with the passing PP film 1 thereabove at the pressing device. The adhesive is formed of a composite material including PP and PE (polyethylene) and is without the composition of solution so as to be environment friendly and cause no harm to human being if the resultant paper container is for food package. At the same time, activate the drying device in room temperature to dry the joined PP film 1 and the paperboard 2 to form a laminated paperboard.

Fourth step: Feed the laminated paperboard to a cutter which is adapted to cut the laminated paperboard into a plurality of first units of predetermined size. The color first paperboard units can be used directly as small containers for packaging goods, food, etc. with a color label shown thereon.

Alternatively, the fourth step can be replaced by a fifth step as detailed below. The laminated color paperboard is adhered to a corrugated fiberboard by means of another pressing device by applying an adhesive and pressing the laminated paperboard and the corrugated fiberboard together to form a thicker paperboard without heating. Preferably, the thickness of the corrugated fiberboard is in the range of 0.2 mm to 1.2 mm. The thicker paperboard is fed to a cutter which is adapted to cut the thicker paperboard into a plurality of second units of another predetermined size. The color second paperboard units can be used for the manufacturing of large containers for packaging goods, food, etc. with a color label shown thereon.

For adhering first and printing second, it involves the following steps.

First step: Place a reel of opaque PP film 1 of (e.g., 12 μm thick and 2.6 m wide) in front of an inlet of a pressing device (e.g., one including two opposing rolls) and align the former with a container filled with a reel of paperboard 2 of (e.g., 260 μm thick and 1,100 mm wide) thereunder. The thickness of the PP film 1 is in the range of 12 μm to 180 μm and the thickness of the paperboard 2 is in the range of 60 μm to 800 μm as required by the invention respectively.

Second step: Activate the pressing device to apply an adhesive on the top surface of the passing paperboard 2 which is adapted to join with the passing PP film 1 thereabove at the pressing device. At the same time, activate a drying device in room temperature to dry the joined PP film 1 and the paperboard 2 to form a laminated paperboard.

Third step: Feed the laminated paperboard to a multiple color gravure machine. The gravure machine can print a color label on the top surface of the PP film 1 of the laminated paperboard. Ink is synthetic ink. Preferably, the consumption of the ink is only about one-third to about one-half as that required by a conventional color printing process.

Fourth step: Feed the laminated color paperboard to a cutter which is adapted to cut the laminated color paperboard into a plurality of first units of predetermined size. The color first paperboard units can be used directly as small containers for packaging goods, food, etc. with a color label shown thereon.

Alternatively, the fourth step can be replaced by a fifth step as detailed below. The laminated color paperboard is adhered to a corrugated fiberboard by means of another pressing device by applying an adhesive and pressing the laminated paperboard and the corrugated fiberboard together to form a thicker paperboard without heating. Preferably, the thickness of the corrugated fiberboard is in the range of 0.2 mm to 1.2 mm. The thicker paperboard is fed to a cutter which is adapted to cut the thicker paperboard into a plurality of second units of another predetermined size. The color second paperboard units can be used for the manufacturing of large containers for packaging goods, food, etc. with a color label shown thereon.

The step of adhering the laminated color paperboard to a corrugated fiberboard can be performed a plurality of times to form a paperboard with desired thickness.

The invention has the following additional advantages. The paper or paperboard can be selected from a wide variety of low quality, low cost paper or paperboard materials. This can significantly decrease the manufacturing cost. No bubbles exist in the laminated paperboard and color registration of the laminated paperboard is precise and thus it is of high quality. The laminated paperboard is a moisture barrier and can prohibit microorganisms from growing. The laminated paperboard is of no bending or twisting. The laminated paperboard can be mass produced easily.

While the invention herein disclosed has been described by means of specific embodiments, numerous modifications and variations could be made thereto by those skilled in the art without departing from the scope and spirit of the invention set forth in the claims.

1. A method of manufacturing a laminated paperboard comprising:
(1) feeding a reel of opaque plastic film to a first pressing device and feeding a reel of paper member under the plastic film to the first pressing device;
(2) activating the first pressing device to apply a first adhesive on a joining surface of the passing paper member and the passing plastic film;
(3) activating a drying device to dry the first adhesive to fasten the plastic film and the paper member together to form a laminated paperboard;
(4) feeding the laminated paperboard to a color gravure device;
(5) activating the color gravure device to print a color label on the top surface of the laminated paperboard by applying ink thereon; and
(6) feeding the laminated paperboard to a cutter for cutting the laminated paperboard into a plurality of units of predetermined size.

2. The method of claim 1, wherein the thickness of the plastic film is in the range of about 12 μm to about 180 μm.

3. The method of claim 1, wherein the ink is synthetic ink.

4. The method of claim 1, wherein the thickness of the paper member is in the range of about 60 μm to about 800 μm.

5. The method of claim 1, wherein the first adhesive is without solution.

6. The method of claim 1, wherein the color gravure device is a multiple color gravure device.

7. The method of claim 1, further comprising the step (5a) between the step (5) and the step (6) of activating a second pressing device to adhere the laminated paperboard to a corrugated fiberboard by applying a second adhesive by pressing them together without heating.

8. The method of claim 7, wherein the thickness of the corrugated fiberboard is in the range of about 0.2 mm to about 1.2 mm.
